(19) United States
(12) Patent Application Publication
(10) Pub. No.: US 2023/0371140 A1
(43) Pub. Date: Nov. 16, 2023

(54) SYSTEM AND METHOD FOR INDUCTION HEATING

(71) Applicant: Magnus Metal Ltd., Tzora (IL)

(72) Inventors: Emil WEISZ, Modi'in-Maccabim-Reut (IL); Gil Lavi, Ness Ziona (IL)

(21) Appl. No.: 17/744,678

(22) Filed: May 15, 2022

(51) Int. Cl. H05B 6/40; H05B 6/10; H05B 6/06

(52) U.S. Cl. CPC H05B 6/40; H05B 6/101; H05B 6/06

(57) ABSTRACT

A heating system for heating multiple working areas of a metallic workpiece, one working area after another according to a heating plan, includes at least one induction heating unit, at least one travel unit, and an induction heating power supply unit. The induction heating unit heats the working areas from a working distance which is greater than a predetermined height. The travel unit provides relative motion according to the heating plan between the induction heating unit and the workpiece at a travel velocity. The induction heating power supply unit provides current at a desired magnitude and frequency, generating therefrom a magnetic field which extends to the working area. The induction heating unit includes at least one hairpin coil at a vertical position with respect to the working areas, and a magnetic flux concentrator (MFC) surrounding the hairpin coil. The MFC increases the range of a magnetic field to include the working areas.

### FIELD OF THE INVENTION

The present invention relates to additive metal casting generally and specifically to additive metal casting employing molten metal deposition and induction heating.

### BACKGROUND OF THE INVENTION

Additive casting systems and methods are described, for example, in US Patent Publication 2020/0206810A1, and in U.S. Patent Applications 63/283,980 and 63/315,096 and in Israel Patent Application No. 283302, all of which are incorporated herein by reference.

Additive manufacturing systems are further described in the article “Shape Deposition Manufacturing” by Merz et al. (L. E. Weiss, R. Merz, F. B. Prinz, G. Neplotnik, P. Padmanabhan, L. Schultz, K. Ramaswami, “Shape deposition manufacturing of heterogeneous structures”, Journal of Manufacturing Systems, Volume 16, Issue 4, 1997, Pages 239-248, ISSN 0278-6125, https://doi.org/10.1016/S0278-6125(97)89095-4, https://www.sciencedirect.com/science/article/pii/S0278612597890954).

Surface treatment of metal layers with induction heating is known in the art, for example, as described in “Evaluation of surface metal layer modification processes under high-frequency induction heating”, AIP Conference Proceedings 2125, 030068 (2019); https://doi.org/10.1063/1.5117450 by V. G. Shchukina and V. N. Popovb.

### SUMMARY OF THE PRESENT INVENTION

There is therefore provided, in accordance with a preferred embodiment of the present invention, a heating system for heating multiple working areas of a metallic workpiece, one working area after another according to a heating plan. The heating system includes at least one induction heating unit, at least one travel unit, an induction heating power supply unit and a controller. The at least one induction heating unit heats the working areas from a working distance which is greater than a predetermined height. The at least one travel unit provides relative motion according to the heating plan between the at least one induction heating unit and the workpiece at a travel velocity. The induction heating power supply unit is coupled to the at least one induction unit and provides current at a desired magnitude and frequency, the induction heating unit to generate from the current a magnetic field which extends to the working area. The controller controls the at least one induction heating unit, the at least one travel unit and the induction heating power supply unit. The at least one induction heating unit includes at least one hairpin coil at a vertical position with respect to the working areas, and a magnetic flux concentrator (MFC) surrounding the hairpin coil. The MFC increases the range of a magnetic field to include the working areas.

Moreover, in accordance with a preferred embodiment of the present invention, the MFC is coupled to a heatsink with a cooling fluid flowing therethrough to cool the MFC.

Further, in accordance with a preferred embodiment of the present invention, at least one induction heating unit includes two or more hairpin coils at a vertical position with respect to the working areas, surrounded by one or more magnetic flux concentrator (MFC) arranged to flow current in the two or more hairpin coils in a common direction.

Still further, in accordance with a preferred embodiment of the present invention, one or more MFCs are coupled to one or more heatsinks with a cooling fluid flowing therethrough to cool the MFC.

Moreover, in accordance with a preferred embodiment of the present invention, the predetermined height is in a range between 2 to 12 mm.

Further, in accordance with a preferred embodiment of the present invention, the travel velocity is in a range between 1 mm/sec to 100 mm/sec.

Still further, in accordance with a preferred embodiment of the present invention, the controller provides the working areas with a target total energy by controlling at least one parameter of a group consisting of: the travel velocity, a provision of electric power to the at least one induction heating unit, heating dwell time at selected locations of the heating path, current magnitude.

Moreover, in accordance with a preferred embodiment of the present invention, the controller provides the working areas with a target current density by controlling at least one parameter of a group consisting of: current magnitude provided to each of the at least one induction heating unit, a working distance of the each of the at least one induction heating unit and the work areas.

Further, in accordance with a preferred embodiment of the present invention, the heating system includes sensors. The controller is responsive to readings of the sensors indicative of at least one parameter from a group consisting of: a temperature of the working areas before heating, a temperature of the working areas after heating, a height of the at least one heating unit above the working areas.

Still further, in accordance with a preferred embodiment of the present invention, the heating system provides the working areas of the metallic workpiece with a target total energy and a target current density based on properties of the metallic workpiece by predetermining at least one parameter of a group consisting of: a target temperature of the working areas, a number of hairpin coils, a length of an active heating bottom part of the at least one induction unit, a shape of a cross-section of the at least one hairpin coil, a shape of the at least one hairpin coil, a shape of the one or more magnetic flux concentrator (MFC), a geometrical relation between the at least one hairpin coil and the one or more magnetic flux concentrator (MFC), an extension of the at least one hairpin coil from the one or more magnetic flux concentrator (MFC) toward the working areas, and an extension of the one or more magnetic flux concentrator (MFC) from the at least one hairpin coil from toward the working areas.

There is provided, in accordance with a preferred embodiment of the present invention, a heating method for sequentially providing multiple working areas of a metallic workpiece. The method includes moving a heating system having one or more induction units over the workpiece at a travel velocity, from a predetermined working distance, determining properties of the metallic workpiece, and controlling at least one operational parameters of the heating system to provide a target total energy and a target current density from the properties, the parameters chosen from a group consisting of: the travel velocity of the one or more induction units over the workpiece, a provision of electric power to the one or more induction heating units of the heating system, a heating dwell time at selected working areas, a magnitude of current provided to the to one or more induction units of the heating system, a current frequency provided to the to one or more induction units of the heating system, and a working distance of one or more induction units of the heating system and the working areas.

Moreover, in accordance with a preferred embodiment of the present invention, the method includes based on properties of the metallic workpiece, predetermining at least one parameter of a group consisting of: a target temperature of the working areas, a number of hairpin coils constituting each of the one or more induction units of the heating system, a length of an active heating bottom part of the one or more induction units, a shape of a cross-section of the at least one hairpin coil, a shape of the at least one hairpin coil, a shape of the one or more magnetic flux concentrator (MFC) included in the one or more induction units, a geometrical relation between the at least one hairpin coil and the one or more magnetic flux concentrator (MFC), an extension of the at least one hairpin coil from the one or more magnetic flux concentrator (MFC) toward the working areas, and an extension of the one or more magnetic flux concentrator (MFC) from the at least one hairpin coil from toward the working areas.

Moreover, in accordance with a preferred embodiment of the present invention, the predetermined working distance is in a range between 2 to 12 mm.

Further, in accordance with a preferred embodiment of the present invention, the travel velocity is in a range between 1 mm/sec to 100 mm/sec.

Still further, in accordance with a preferred embodiment of the present invention, the method includes adjusting at least one operational parameter of the heating system in response to one or more sensor readings of a group consisting of: sensor readings indicative of a temperature of the working areas before heating, sensor readings indicative of a temperature of the working areas after heating, and sensor readings indicative of a height of the one or more induction units above the working areas.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an example of a casting system incorporating a metal deposition unit according to embodiments of the invention;

FIG. 2 illustrates a metal deposition unit according to embodiments of the invention;

FIGS. 3A and 3B are side and bottom views of a metal deposition unit according to embodiments of the invention;

FIG. 4 is a graphical illustration of considerations relevant to the design and operation of a metal deposition system and a heating system according to embodiments of the invention;

FIG. 5 further illustrates considerations relevant to the design and operation of a metal deposition system and a heating system according to embodiments of the invention;

FIGS. 6A, 6B and 6C illustrate a pre-deposition unit according to embodiments of the invention;

FIGS. 7A, 7B, 7C and 7D further illustrates a pre-deposition unit according to embodiments of the invention;

FIGS. 8A and 8B illustrate a performance simulation of a heating system according to embodiments of the invention;

FIG. 9 illustrates a performance simulation of a heating system according to other embodiments of the invention;

FIG. 10 is a flow chart of a deposition method according to embodiments of the invention;

FIG. 11 illustrates a heating system according to embodiments of the invention; and

FIG. 12 is a flow chart of a heating method according to embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

According to an aspect of the invention, there is provided a metal deposition system and method thereof. The metal deposition system may be integrated with an additive casting system and may be operable therewith for the casting of an object additively by producing multiple production layers having mold regions of predetermined mold region heights and object regions defined by the mold regions, one currently-produced production layer after the other.

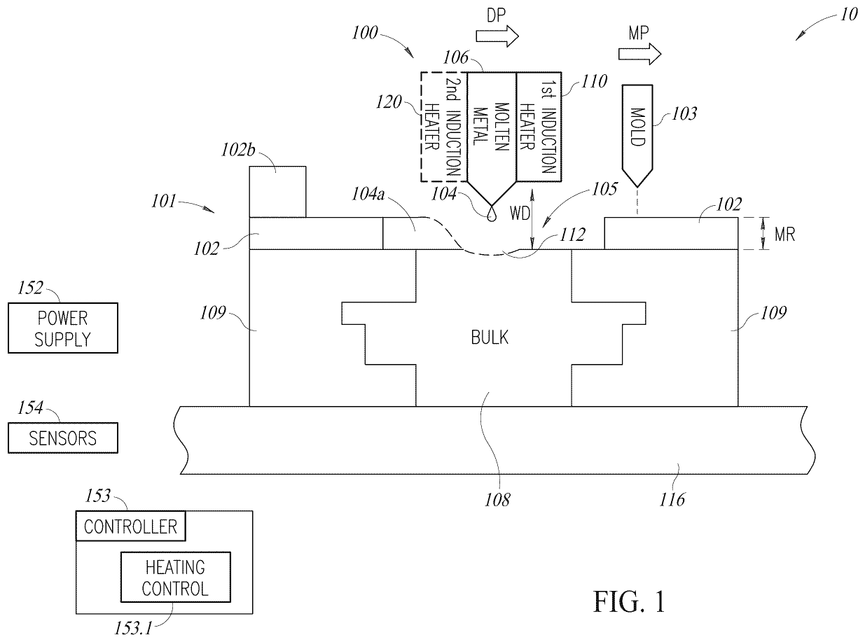

FIG. 1, to which reference is now made, illustrates an additive casting system 10 that incorporates a movable metal deposition system 100 according to embodiments of the invention.

Additive casting system 10 is configured to additively produce multiple production layers, one currently-produced production layer 101 after the other on a build table 116. For each currently-produced production layer 101 (also referred to herein as a build plane), a movable mold construction unit 103, along a mold path MP, may construct mold regions 102 defining object regions 105. Mold regions 102 include at least one cavity into which the molten metal may be deposited. Mold regions 102 may include cavities, inserts, supports, recesses, and the like. Once the mold region/s of a production layer are complete, a movable deposition unit 100 may deposit molten metal 104 along a deposition path DP at working areas 112 in the object regions 105 to be fabricated.

Movable deposition unit 100 comprises a movable molten metal deposition module 106 for depositing molten metal 104 in multiple working areas 112. In some embodiments, molten metal is deposited as one or more molten metal drops. In other embodiments, a stream of molten metal is provided.

In some embodiments, the deposition module 106 utilizes a metal rod with a tip. The tip is heated to a desired deposition temperature. In some embodiments, the deposition module 106 utilizes a crucible containing molten metal. The invention is not limited by the manner in which the deposition module 106 is realized.

Movable deposition unit 100 further comprises a movable first induction heating module 110 (also referred to herein as first heater 110). Deposition unit 100 may optionally comprise a movable second induction heating module 120 (also referred to herein as second heater 120).

For ease of explanation, embodiments of the invention will be explained mainly with reference to the first heater as configured for heating the working areas 112 prior to molten metal deposition (pre-deposition heating) and the second heater as configured for heating the working areas 112 after molten metal deposition (post-deposition heating)—but this is not necessarily so. The invention is not limited to this configuration, as will be detailed herein.

The deposition system scans the multiple working areas. A typical and convenient scanning style is the well-known raster scan. The deposition system may be required to scan the multiple working areas with some overlapping, scan around corners and along curved lines. The invention is not limited by the scanning type and style.

According to embodiments of the invention, the movable molten metal deposition module 106, the movable first induction heating module 110, and optionally the movable second induction heating module may each be associated with a dedicated movement module (not shown). The three dedicated movement modules may provide their assigned module (106, 110, 120) with independent translational movement along the X and Y axes across the build plane and along the Z-axis (height with respect to the build plane). The three dedicated movement modules may provide their assigned module (106, 110, 120) with rotational movement.

According to an embodiment of the invention, the movable molten metal deposition module 106, the movable first induction heating module 110, and optionally the movable second induction heating module may be physically coupled and may share a common movement module (not shown). The common movement module may provide modules 106, 110, and 120 with a shared translational movement along the X and Y axes across the build plane and along the Z-axis (to change the unit's working distance above the build plane).

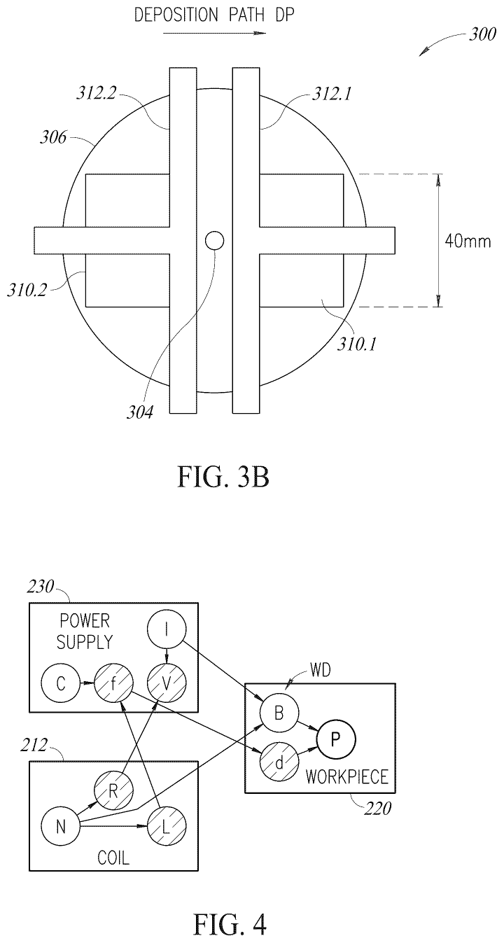

In some embodiments, modules 110 and 120 may be provided with a rotational movement mechanism for rotational movement in the X-Y plane around the deposition module 106 (rotation with respect to axis A shown in FIG. 3B).

In some embodiments, the movable heating module/s may be provided with a rotational movement mechanism for a yaw rotational movement with respect to the deposition path or with respect to crucible 106. If there are multiple heating modules, they may rotate separately or together.

The invention is not limited by the type of motion technique. In some embodiments, robots may be used. In other embodiments, a gantry system or other system may provide movement in the X, Y, and Z directions. Further, the invention is not limited to the example of FIG. 1—utilizing a movable deposition system, movable induction heating system, and movable mold system. In some embodiments, relative movement between the deposition system, induction heating system, and other components of the casting system and the workpiece is realized by moving the workpiece (e.g., by an electrical-mechanical stage).

FIG. 1 depicts the fabrication of the currently-produced production layer 101 after a series of previously-produced production layers were fabricated, yielding a bulk 108 of object regions and a stack 109 of mold regions.

Additive casting system 100 further comprises a controller 153 for controlling at least the movable mold constructing unit 103 and the movable deposition unit 100 to form the mold regions 102 and object regions 105 in accordance with a building plan. Controller 153 may be implemented digitally or via one or more analog control systems.

According to the embodiment of the invention employing pre-deposition heating, controller 153 may be further operative to control a desired pre-deposition induction heating of the working areas by controlling the operation of the first and/or second movable induction heating units.

According to the embodiment of the invention employing post-deposition heating, the controller is further operative to control a thermal cooling profile of the deposited metal by controlling the operation of the first and/or second movable induction heating units.

According to an embodiment of the invention, the first induction heating module 110 is designed to provide heat, under the control of controller 153, to the working areas 112 at a working distance WD which is greater than a height MR of the mold region 102a. In some embodiments, the mold region height MR may be in a range between 2 mm to 12 mm.

According to embodiments of the invention, the first heating module 110 may provide heat before metal deposition, and the second heating module 120 may provide heat after metal deposition. For example, the first induction heating module 110 may be configured to travel on the deposition path DP ahead of the deposition module 106; the second heating module 120 may be configured to travel on the deposition path DP after the deposition module 106. In some embodiments, the first heating module 110 and the second heating module 120 may be physically coupled to the deposition module 106 and may share a common travel mechanism allowing the first heating module 110 to lead the way along deposition path DP. Other types of unidirectional travel may apply.

According to embodiments of the invention, the function of the first induction heating module 110 and the second induction heating module 120 as providers of pre-deposition heating and/or post-deposition heating depends on the positioning of the deposition unit 106 on the deposition path. For example, the deposition unit may travel back and forth over the built plane. In one direction, the first induction heating module 110 may lead the way and may provide heating before metal deposition (pre-deposition heating). In the other direction, the second induction heating module 120 may lead the way and may provide heating before metal deposition. Other types of bidirectional travel may apply.

Additive casting system 100 may further comprise a power supply 152 for supplying power to at least the deposition system 100. Power supply 152 may be coupled to and controlled by controller 153.

Additive casting system 100 may further comprise one or more sensors 154. Sensors 154 may be configured to sense at least a temperature of working areas 112 in the object regions 105 to be fabricated. Controller 153 may be further operative to respond to the readings of sensors 154, for example, by adjusting the operation of at least the movable molten metal deposition module 106, the movable heating module 110, and optionally, the operation of the movable heating module 120.

Sensors 154 may sense additional parameters, including one or more of: the temperature of the molten metal to be deposited before and/or during deposition; the chemical composition of the molten metal to be deposited before and/or during deposition; to measure the height of the deposition unit 100 or components thereof (e.g., the heights of the first heater 110, deposition module 106 and the second heater above the build plane); to measure the volume of deposited metal, and more.

Controller 153, in response to the readings of sensors 154, may instruct the movement system (not shown) to adjust and hold a constant height above the build plane.

The invention is not limited by the mold fabrication technique. In some embodiments, in-situ techniques may be used. For example, mold construction unit 103 may comprise a mold material reservoir (not shown) and a mold material dispensing assembly (not shown) in connection therewith, to additively dispense a mold material in predefined locations to form mold regions 102 according to the build plan. In other embodiments, ex-situ mold fabrication may be applied. For example, the mold construction unit may include a plurality of remotely-produced mold structures (not shown) and may comprise a mold transfer unit (not shown) operative to transfer a remotely-produced mold structure to a predefined location in the current fabrication layer 101 according to the build plan.

According to an embodiment of the invention, system 10 further comprises an inert gas unit (not shown). At least a portion of system 10 may be maintained in an inert atmospheric environment during pre-heating and metal deposition.

As mentioned hereinabove, movable deposition unit 106 may deposit molten metal in multiple working areas 112 at the object region of the currently-produced production layer according to a building plan. The building plan may set a deposition path and a deposition velocity.

As mentioned hereinabove, due to the presence of the mold regions 102, metal deposition system 100 may remain at a working distance WD above the deposition surface.

In some embodiments, the working distance WD may be maintained over the entire build plane. For example, the working distance WD is maintained as mold height+a fixed delta in the range of 2 mm to 5 mm. In some embodiments, the working distance WD may vary in specific areas of the build plane. In some embodiments, the deposition system 100 may be positioned close to the build plane, with a working distance WD that is smaller than the mold region height. For example, in large objects (e.g., with a diameter larger than 20 cm), at working areas that are located away from the mold regions.

Applicant has realized that when depositing molten metal at a working area (a “voxel”) at a working distance above the mold region height, the voxel may not attach to the previous layer if the previous layer is cold. Therefore, the first and/or second induction heater may be designed to convey sufficient energy from the working distance WD to the working area in the object region where new molten metal will be deposited so as to support the receipt of the molten metal by the receiving working area.

According to embodiments of the invention (referred to herein as melt pool embodiments), the molten metal to be deposited and the working area should ideally have the same temperature. Therefore, the pre-heater or the heating induction module, may be configured to convey energy to the working area in the object region sufficient to generate a desired melt pool in the working area.

According to other embodiments of the invention (referred to herein as over-heating embodiments), the molten metal to be deposited may carry some of the energy to be conveyed to the working area (for example, by over-heating the molten metal to be deposited above a metal melting temperature). Therefore, the pre-heater may be configured to convey energy to the working area in the object region sufficient to heat the working areas to a below-melting state.

In addition, Applicant has realized that the first heating unit and optionally the second heating unit and the deposition unit continuously move over the workpiece. Thus, in the melt-pool embodiments, a continuous melt pool trail and continuous molten metal flow may be created. In each working area, the melt pool cools down mm behind the pre-heater, while the deposition unit moves above the working area.

For example, the deposition unit may deposit metal voxels of 1 cm³ at a rate of 1 cm³/s. The deposition unit may advance at a deposition velocity of 1 cm/s.

Applicant has realized that a shallow melt pool cools down fast and possibly too fast; however, making the melt pool too deep is a waste of energy and time. Applicant has determined that a melt pool of 15-25 mm width, for example 17 mm, which provides a depth of 3-10 mm, for example, 5 mm is sufficient to receive such 1 cm³ voxels. However, given that (1) the molten metal is only deposited after pre-heating has stopped, and (2) the angle of heating may not be perpendicular, and taking into consideration (3) the thermal and electrical properties of the metal, Applicant has determined that, for grey iron, a common manufacturing material, the desired geometry of a melt pool may be an initial width of 20 mm and an initial 5 mm depth and that the desired energy density to create such a melt pool may be 10 Kw/cm² and above.

Similar considerations may apply to the over-heating embodiments of the invention.

In some embodiments, power supply 152 may be a high-current power supply which may generate the desired heating. In other embodiments, the pre-heating induction module may provide focused induction heating at a distance via a magnetic flux concentrator (MFC) placed around a hairpin coil having cooling means therein.

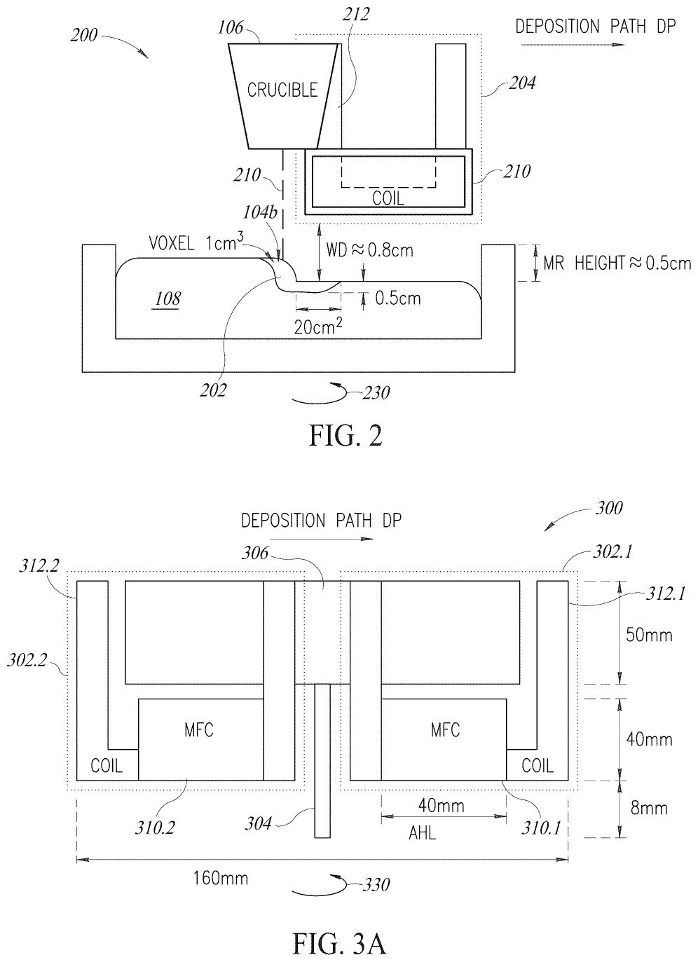

Reference is now made to FIG. 2, which is a partial illustration 200 of the deposition system 100 of FIG. 1, and details the pre-heating and deposition operations. FIG. 2 shows crucible 106 (being a portion of deposition module 106 illustrated in FIG. 1) producing droplets 104, one of which, 104b, has landed on a bulk 108. Bulk 108 shown in FIG. 2 is shown as being a portion of bulk 108 illustrated in FIG. 1, and includes the previously deposited metal 104a of the currently-fabricated layer 101, as illustrated in FIG. 1. Upon deposition and the optional post-deposition heating operation, the previously-deposited metal of the currently-fabricated layer 102 (illustrated in FIG. 1) and the previously-deposited metal of the previously-produced layers form a heatsink illustrated in FIGS. 1 and 2 as bulk 108.

FIG. 2 further shows a pre-deposition induction heater 204 (being a portion of pre-deposition induction heating module 100 illustrated in FIG. 1), constructed and operative in accordance with an embodiment of the invention, to generate a melt pool 202 of 20 mm width and 5 mm depth from a working distance WD of about 8 mm.

In accordance with an embodiment of the invention, pre-deposition heater 204 comprises a magnetic flux concentrator MFC 210 through which runs a hairpin coil 212, typically formed of a copper tube. Hairpin coil 212 may be bent to a U shape, the U-shape bottom part defining the active heating length, but this is not necessarily so. The invention is not limited by the geometrical properties, and other coil cross-sections and shapes may be provided, as described hereinbelow. The invention is not limited by the material used for coil 212. Copper alloys such as bronze and any other conductive material may be used.

During operation, water (or other coolant material) may flow through the coil and/or a heatsink may be coupled to magnetic flux concentrator MFC 210 (a so-called cooling jacket, not shown in FIG. 2), to cool magnetic flux concentrator MFC 210.

Heater 204 may be of low resistance, thus requiring a low voltage to generate a high current, and may be capable of operating at a high frequency. Heater 204 may be load-matched with a power supply (element 152 in FIG. 1) to maximize the power transfer at the desired operating frequency.

FIG. 2 also shows a yaw rotational movement, labeled 230, with respect to crucible 106.

FIGS. 3A and 3B are side and bottom views of a metal deposition unit 300 according to embodiments of the invention employing two identical induction heaters 302.1 and 302.2 that are physically coupled to a deposition module 306, similar in operation to deposition module 106 of FIG. 1.

Both heaters 302.1 and 302.2 may be capable, under the control of a controller (e.g., controller 153 of FIG. 1) of providing pre-deposition induction heating and/or post-deposition induction heating. In the example of FIGS. 3A and 3B, induction heating unit 302.1 leads the way on the deposition path DP and functions as the pre-deposition heater, while induction heating unit 302.2 functions as the post-deposition heater.

As illustrated in FIGS. 3A and 3B, the induction heating units 302.1 and 302.2 comprise coils 312.1, 312.2, and MFCs 310.1, 310.2, respectively.

FIGS. 3A and 3B depict an exemplary geometrical arrangement of the deposition system 300: MFCs 310.1 and 310.2 may be 40 mm tall and 40-100 mm wide and coils 302.1 and 302.2 may extend 100 mm from the bottom of MFCs 310.1 and 310.2 to the top of deposition module 300. The length of the deposition module 300 may be 160-280 mm and an active heating length AHL, which may be defined by the length of the bottom portion of coils 312.1, 312.2, may be 40-100 mm each (i.e. the length covered by each MFC 310).

FIG. 3A also shows a path, labeled 304, along which a drop or stream of molten metal falls, between pre- and post-heaters 302.1 and 302.2. Path 304 may have a total height composed of (1) 40 mm defined by the height of MFC 310.1, 310.2 plus (2) the working distance WD of 8 mm, above a mold region height MR of about 5 mm.

In the embodiment illustrated in FIGS. 3A and 3B, one or both of heating modules 310.1, 310.2 may be provided with a yaw rotational movement, labeled 330, with respect to a deposition module 306. In some embodiments, the yaw rotation movement is separate. In other embodiments, both of heating modules 310.1, 310.2 share the yaw rotational movement.

The exemplary geometrical arrangement of the deposition system 300 in FIG. 3A illustrates the challenge of heating the working area from a working distance larger than the mold region height. The molten metal loses heat as it falls to the workpiece while the induction heating units need to heat at a distance from the workpiece.

In some embodiments, heat generated by one or both induction heating units 302.1 and 302.2 is also utilized to heat the molten metal along the passage from the deposition unit 306 to the working area.

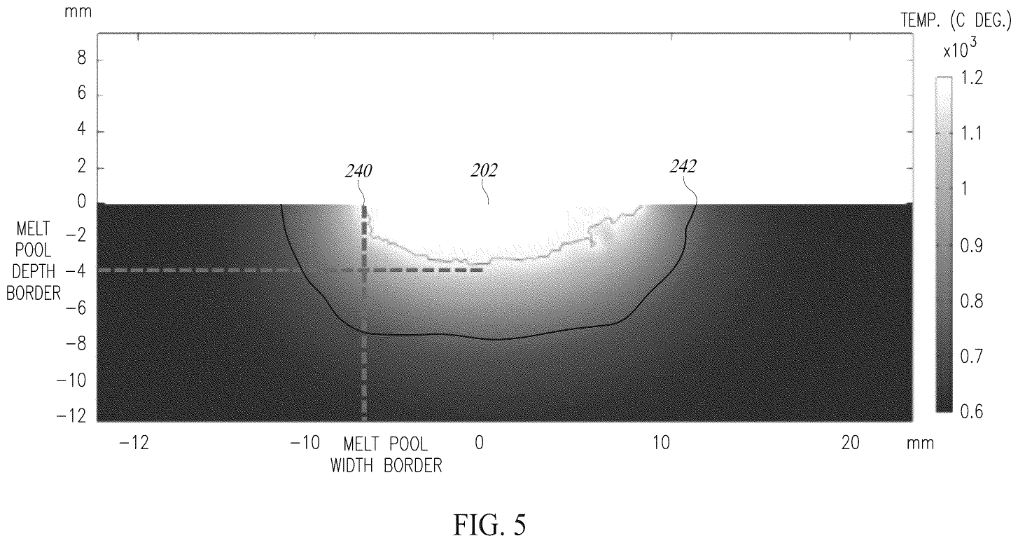

FIG. 4 illustrates considerations relevant to the design and operation of a metal deposition system according to embodiments of the invention. FIG. 4 will be discussed with reference to deposition system 200 shown in FIG. 2: Power supply 230 may provide a current I to hairpin coil 212 to generate a magnetic field (shown as B in FIG. 4) in workpiece 220 in order to generate melt pool 202 in workpiece 220. Thus, melt pool 202 is a function of power supply 230, hairpin coil 212, work piece 220, and working distance WD.

As shown in FIG. 4, power supply 230 is defined by a capacitance C, which affects an excitation frequency f, and by current I, which defines the voltage V. Hairpin coil 212 may have N turns. FIGS. 3A and 3B show hairpin coil 212 with one turn but more turns are possible. The number of turns N defines the coil resistance R, and coil inductance L. Inductance L affects excitation frequency f of power supply 230 while coil resistance R affects voltage V of power supply 230.

As mentioned hereinabove, current I, which flows through the N turns of coil 212, induces magnetic field B. Magnetic field B operates on workpiece 220 from working distance WD, where the farther away workpiece 220 is, the less of magnetic field B workpiece 220 will feel and thus, the less heat will be generated in workpiece 220.

The frequency f of power supply 230 induces a current B in workpiece 220, which current B has skin depth d. The frequency of the current B affects the skin depth d, which affects the electric coupling of the coil 212 to the workpiece. Higher frequency f improves coupling and thus improves the transfer of energy from coil 212 to the workpiece.

The power P at workpiece 220 is a function of magnetic field B, working distance WD, and skin depth d. The size of the resultant melt pool 202 is also a function of the properties of the metal being heated.

Once the desired size of melt pool 202 is defined, the parameters of power supply 230 may be determined as a function of the number of turns N of coil 212. Once these are fixed, additive casting system 100 (FIG. 1) may control current I and the speed of motion above workpiece 220 (the working area onto which molten metal will be deposited).

For example, a melt pool in Grey Iron of initial width of 20 mm and 5 mm depth may be generated by a power supply of 2400 A and a double hairpin coil (i.e. N=2) or a power supply of 3000 A and a single hairpin (i.e. N=1).

FIG. 5, to which reference is now made, shows a thermal simulation of melt pool freezing and temperature of the adjacent area as a function of time. For example, melt pool 202 may be generated with the pre-deposition heater discussed with reference to FIGS. 1 and 2, having a bottom length (effective heating length) of 5 cm and moving over a specific working area at a progression velocity of 1 cm/sec. Under the above-listed operational conditions, each working area experiences heating for a heating period of 5 sec. The melt pool starts to cool down as soon as the pre-deposition heater continues its travel, and heating of the specific working area stops. The desired lapse time between the end of heating and metal deposition in the specific working area may be fixed, e.g., as 1 sec.

FIG. 5 depicts a snapshot of the thermal simulation of melt pool size and temperature at time=1.0013 sec. after melt pool creation (after the end of heating). The temperature of a specific working area and its vicinity is shown using the gray-scale temperature scale. Two phase-change contours 240 and 242 are shown.

The simulated melt pool 202 was generated with an initial width of 20 mm and a depth of 5 mm. In about 1 sec after heating has stopped (i.e., when molten metal 104 is expected to reach workpiece 220), the material within inner phase contour curve 240 may be at a temperature above the melting temperature (e.g., 1150° C. for grey iron) and thus liquid. The temperature of the material within intermediate phase contour curve 242 may be above the Curie temperature (Curie point), the temperature above which magnetic materials lose their ferromagnetic properties (770 deg. C. for gray iron).

Note that, while outer curve 242 may extend from 20 mm (from −10 mm to +10 mm), at this point in time, inner curve 240 extends only from −8 mm to +8 mm. As depicted in FIG. 5, at 1.0013 seconds after melt pool creation, the width of the melt pool is decreased from 20 mm to about 17 mm. In addition, the melt pool depth is decreased from 5 mm to about 4 mm.

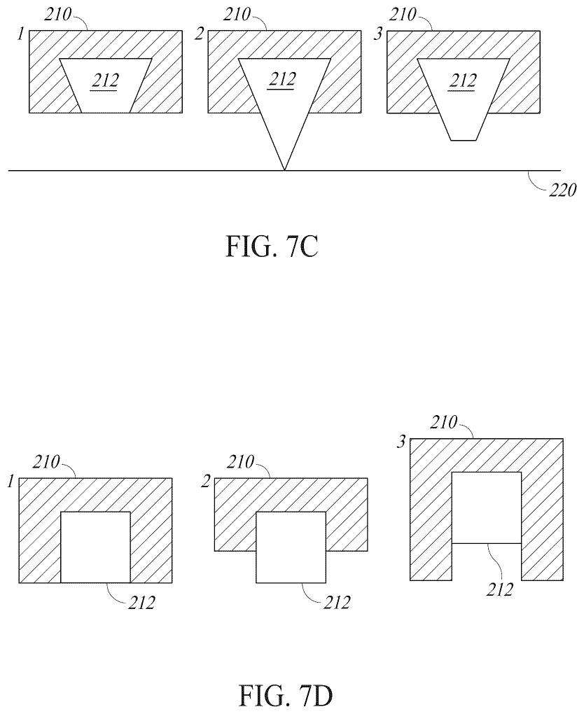

Thus, in order to achieve the desired melt pool with a 20 mm width and 5 mm depth at the deposition time (1 sec after melt pool creation time), additional heating of melt pool 202 is needed. The additional heating may be achieved, for example, by pre-setting the design parameters of the pre-deposition heater (for example, the effective heating length of the pre-deposition heating unit, the geometrical design, and more) or by affecting controllable parameters such as progression velocity, the total current applied to the pre-deposition heater and more, as will be discussed with reference to FIGS. 7-9.

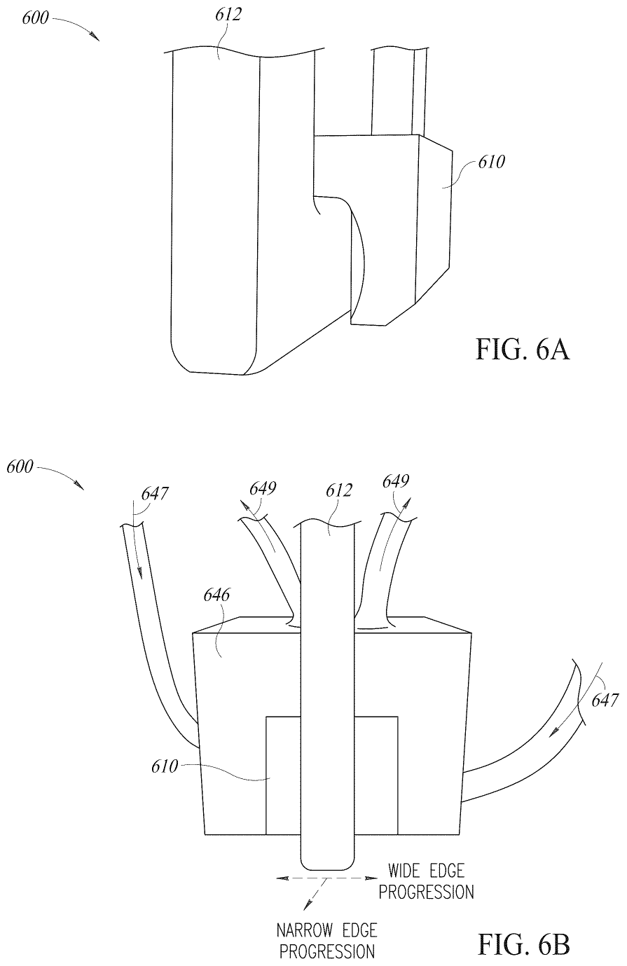

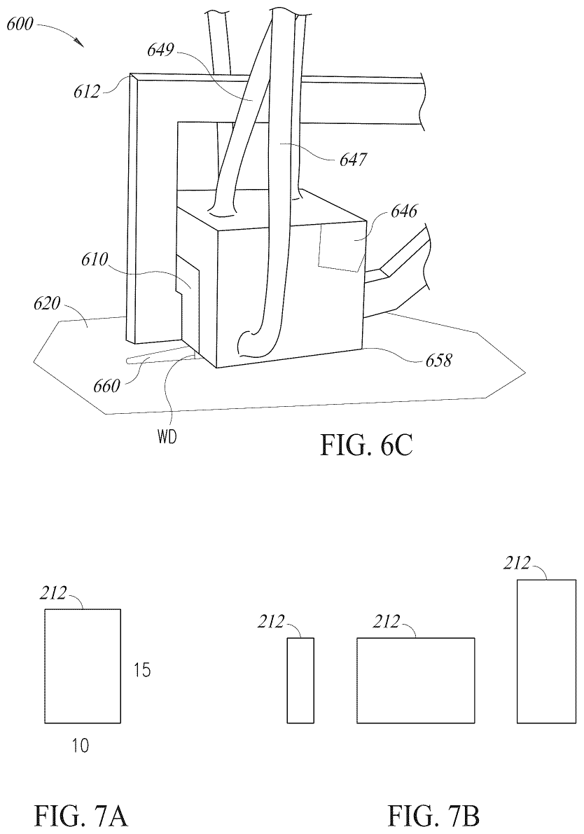

Reference is now made to FIGS. 6A, 6B and 6C, which illustrates an exemplary heater 600, usable for pre-deposition or post-deposition, from three side and perspective views, respectively. In the embodiment shown in FIGS. 6A, 6B and 6C, hairpin coil 612 may be a vertical hairpin coil having a tube cross-section of 15×10 mm. Magnetic flux concentrator MFC 610 may surround the coil tube 612. MFC 610 may be 8 mm thick and 50 mm long. MFC 610 may be connected to the hairpin coil 612 via an epoxy interface (not shown). A heatsink 646 (FIG. 6B) may surround MFC 610. Heatsink 646 may have one or more cooling regions—two are shown in FIG. 6B, with an influx 647 of cooling fluid at the bottom and an outflux 649 of cooling fluid at the top. Heatsink 646 may be made of Bronze or any other thermally conductive material. Heatsink 646 may be connected (e.g., glued) to MFC 610 with a thermal paste (not shown).

FIG. 6A depicts hairpin coil 612 and MFC 610. The U-shape of coil 612 is shown. The tube cross-section of coil 612 is shown. The invention is not limited by the shape of coil 612 and by the cross-section type of coil 612.

FIG. 6B shows heating unit 600 with coil 612, MFC 610, and heatsink 646. Two influx tubes 647 and two outflux tubes 649 of cooling fluid are shown. FIG. 6B shows two main progression directions: a narrow-edge progression direction and a wide-edge progression direction. In the narrow-edge progression direction, the hairpin coil 610 advances along an axis parallel to active heating length AHL (FIG. 3A) (i.e. in a direction out of the paper). In the wide-edge progression direction, hairpin coil 610 advances along an axis perpendicular to active heating length AHL.

FIG. 6C shows the heating unit 600 in operation and depicts a snapshot of the heating unit 600 during progress over workpiece 620 (metallic plate) at a working distance WD. During the progress of the heating unit 600 over the metallic plate, a melt pool trail 660 is created in workpiece 620.

Reference is now made to FIGS. 7A, 7B, 7C and 7D, which illustrate options for cross-sections of the hairpin coil (e.g., element 212 in FIG. 2) with the magnetic flux concentrator (e.g., MFC 210 in FIG. 2) in the single-coil configuration.

FIG. 7A depicts an example coil 212 with a rectangular cross-section of 10 mm×15 mm.

Hairpin coil 212 may have a rectangular cross-section of any aspect ratio—three examples are depicted in FIG. 7B.

The width of the rectangular cross-section sets the current density and thus the energy flux density that is conveyed into the workpiece. The cooling of the MFC is set by the circumference of the coil—except for the coil's bottom face. The height of the rectangular cross-section impacts cooling—a larger height allows for running more cooling water through the cooling pipe/s.

As shown in FIG. 7C, hairpin coil 212 may have a trapezoidal cross-section (views (1), (3)) or a triangular cross-section (view (2)). The trapezoidal and triangular cross-sections improve the effect of water cooling compared to the rectangular cross-sections without reducing the current density on the active heating part of the coil (i.e. coil's bottom face that faces the workpiece).

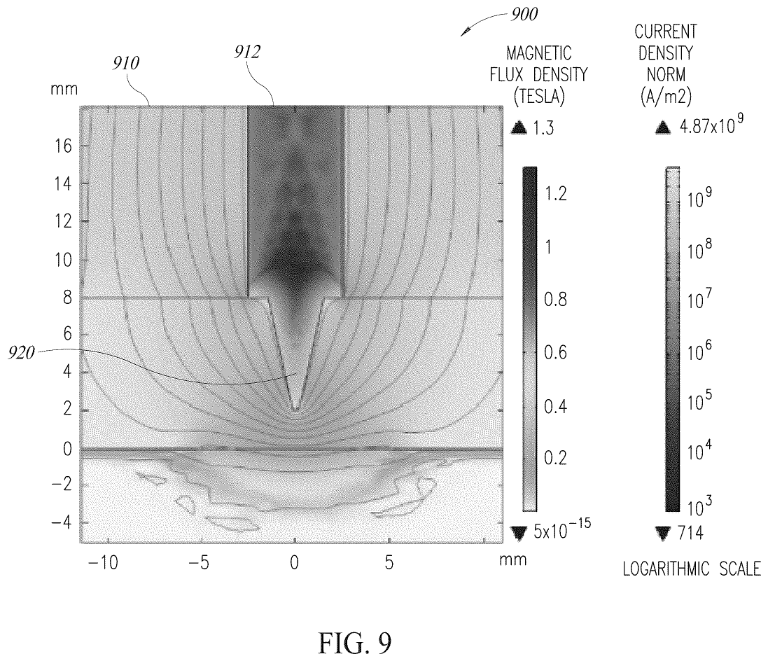

In the trapezoidal cross-section of view (1), the bottom section of coil 212 and the bottom section of MFC 210 share the same working distance from the workpiece 220. In the trapezoidal cross-section of view (3), the bottom section of coil 212 is closer to the workpiece 220—a shorter working distance from the workpiece 220. In the triangular cross-section of view (2), the bottom section of coil 212 extends beyond the bottom section of MFC 210 and is closer to workpiece 220. The term working distance WD (as depicted in view (3) of FIG. 6) relates to the working distance of the lower part of the heating unit 200. In the example of the triangular cross-section illustrated in FIG. 7C, the working distance of the heating unit 200 from workpiece 220 would be the distance from the triangular cross-section tip of coil 212 from the workpiece 220. This embodiment will be further detailed with reference to FIG. 9.

FIG. 7D depicts three examples of different geometrical relations between coil 212 and MFC 210. Various combinations of shapes, cross-sections, and geometrical relationships of the coil 212 and MFC 210 may yield different current densities that are applied to the workpiece 220. Magnetic flux concentrator 210 may entirely or partially cover hairpin coil 212. However, any areas not covered by magnetic flux concentrator 210 may not receive the increased magnetic field provided by magnetic flux concentrator 210.

In some embodiments, for an operational scenario that prioritizes maximal current density (maximal current at minimal coil footprint), combination (1) of FIG. 7D may be most effective compared to combinations (2) and (3). In other embodiments, for example, utilizing a multiturn coil arrangement, a gapped configuration as illustrated in view (3) of FIG. 7D, may be the most efficient.

For the multiple-coil configurations, various options for coil cross-section and relations between MFC and coil geometry are feasible, in alignment with the concepts illustrated in FIGS. 7A-7D.

Applicant has determined that, for a working distance of 8 mm, a hairpin coil having a rectangular cross-section with a 5 mm width and fully covered by a magnetic flux concentrator except at the active heating length at the coil's bottom, provides the desired magnetic field to generate a 20 mm×5 mm melt pool.

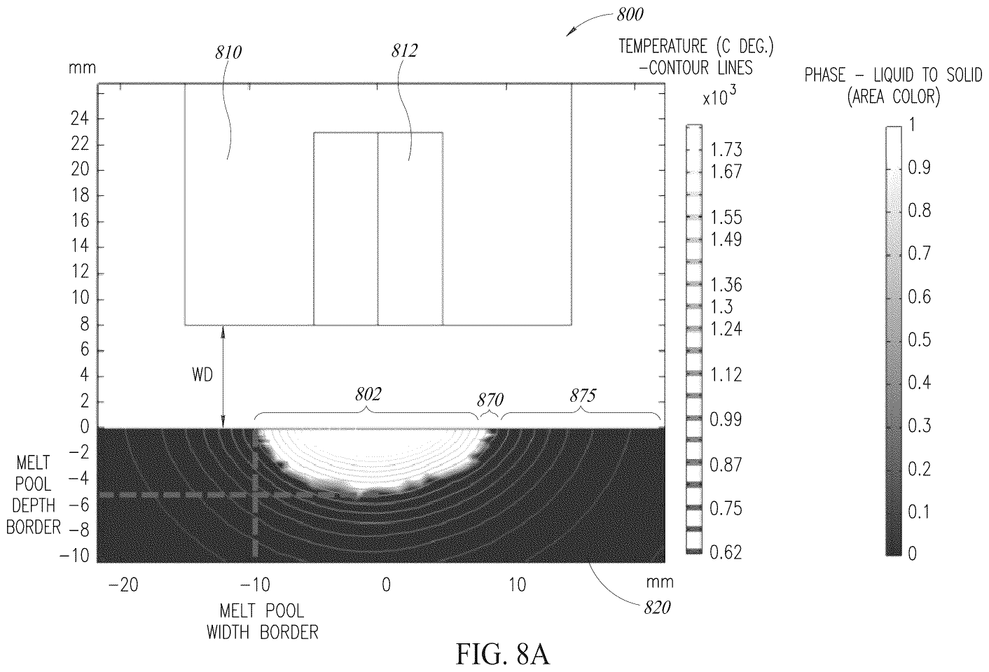

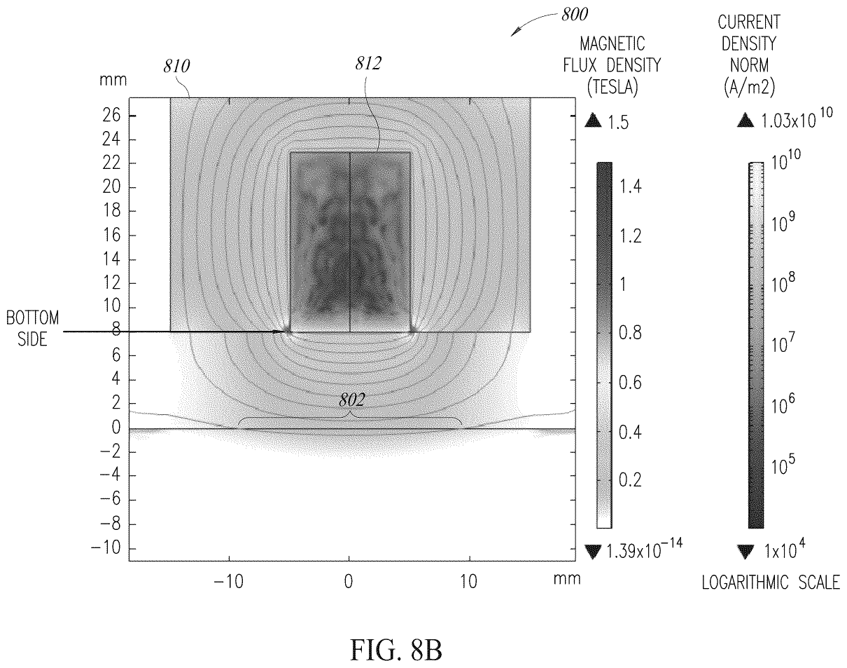

Reference is now made to FIGS. 8A and 8B, which illustrate a performance simulation of an exemplary heater 800 using a double hairpin 812, with an effective heating length of 10 mm in the narrow-edge progression direction, and covered by a magnetic flux concentrator 810. Double hairpin 812 may receive 1.8 kA of power at a frequency of 115 kHz. Double hairpin 812 may expose a specific working area 820 for 5 sec (where an exposure period is the period during which the effective heating length passes over the specific working area) from working distance WD of 8 mm.

FIG. 8A shows the melt pool 802 at the end of the 5 sec. exposure period.

As can be seen in FIG. 8A, in response to the heating applied by the heater 800, a 20 mm×5 mm melt pool 802 is generated in the specific working area. Three phases are depicted in FIG. 8: a liquid phase (melt pool 802), a solid phase 875 and an interim phase 870. FIG. 8A shows, by temperature contour gray colors, the temperature in the three phase areas. The temperature in melt pool 802 is above 1150 deg. C., the melting temperature for gray iron.

FIG. 8B shows the current density norm (in A/m2) at the double hairpin coil 812 and the magnetic flux density (in Tesla). FIG. 8B shows the current density within the double hairpin 812 and the magnetic field in and surrounding heater 800.

As can be seen in FIG. 8B, in the presence of the magnetic flux concentrator 810, most of the current density within the double hairpin 812 resides at the bottom side of the double hairpin 812. Thus, the heat generated by the heater 800 is efficiently focused on the surface of the workpiece to be heated. In response, melt pool 802 is created.

Applicant has determined that a higher current density in hairpin coil 812 may translate to wider and deeper melt pools.

According to embodiments of the invention, the maximum current density is achieved by a combination of pre-set design parameters of the heater and controllable parameters that can be affected during operation.

The pre-set design parameters of the heater may comprise one or more parameters from a group consisting of: coil material; coil geometry—shape, cross-section shape, length of the coil section facing the area to be heated (effective heating length of the heater); a number of coils (for example, a single hairpin coil, double hairpin coil or other multiple coils); magnetic flux concentrator parameters such as material and shape; the geometrical relationships between the coil's and the MFC; MFC cooling heatsink parameters such as material, shape, coolant material, cooling configuration; minimal working distance; deposition-related parameters such as the target deposition temperature, minimal and maximal metal deposition rate.

Controllable parameters of the heater that can be affected during operation may comprise one or more parameters from a group consisting of: total current applied to the heater; current frequency; progression velocity of the heater; progression velocity of the deposition unit (which, in case the heater is physically coupled to the deposition unit, is identical to the progression velocity of the heater); heat exposure period, and metal deposition rate.

The combination of design parameters and controllable parameters may be selected to address operational needs for optimizing the total energy provided to the working area and the current density at the active heating part of the heating unit.

For example, to maximize current density, the total current to be applied may need to be increased. The current increase may be achieved by supplying higher current levels, and in such a case, the use of magnetic flux concentrators (and consequently, MFC heatsink) may be obviated. However, the use of a high current supply may not suit all operational needs.

Current density may be maximized by decreasing the coil width (footprint)—the effective geometrical dimension of the coil section facing the area to be heated. Thus, narrow coils may be preferred for some embodiments. In some embodiments, double, triple, or another number of multiple coil arrangements may be used. Multiple coil arrangements facilitate, for the same current supply, the increase of the total current at the cost of increased coil footprint.

FIG. 9 shows the current density norm (in A/m2) at a hairpin coil 912 employing a triangular coil shape extending below the lower end of MFC 210—for example, as shown in FIG. 7C, view (2) (also referred to as a spur 920, or a knife-edge shape). FIG. 9 further shows the magnetic flux density (in Tesla). FIG. 9 shows the current density within the hairpin 912 and the magnetic field in and surrounding 900. The spur shape of coil 912 may enable the coil to be selectively placed closer to workpiece 220. FIG. 9 depicts an effective working distance of 2 mm.

As can be seen in FIG. 9, in comparison with FIG. 8, the decrease of coil footprint facilitates the increase of current density. The change of a pre-set parameter such as the geometrical parameters of the heater and a controllable parameter such as the working distance may yield higher current density, which, in turn, may be translated to change other operational parameters, such as total current and exposure time.

In some embodiments, the heat exposure period may be extended: to attempt to give initial areas of each trail of melt pools similar conditions as for other portions of the trail, the heater (e.g., heater 200 of FIG. 2, heater 800 of FIG. 8) may remain at the beginning of a trail for a short dwell time, which may be adjusted according to the velocity of the heater.

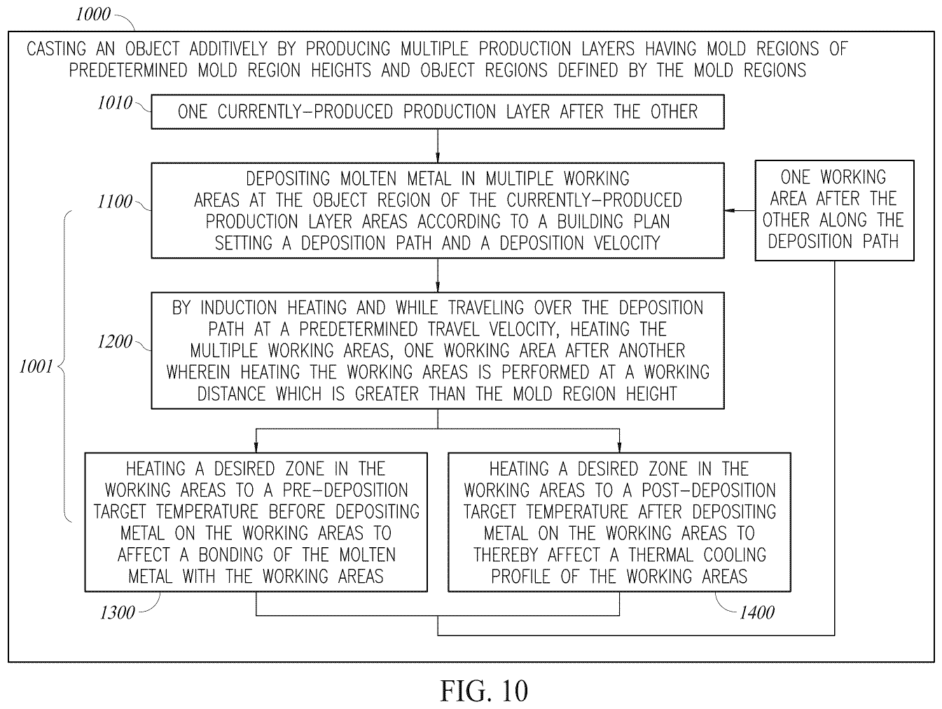

FIG. 10 is a flow chart of a deposition method 1001, used, for example, for the additive casting of a metal object. The additive casting process 1000 is carried out sequentially by a sequence of operations 1010 of producing multiple production layers having mold regions of predetermined mold region heights and object regions defined by the mold regions, one currently-produced production layer after the other. The operation of producing the mold regions of predetermined mold region heights (not shown in FIG. 10) is performed before producing the object regions by metal deposition.

Method 1001 of metal deposition in the currently-produced production layer comprises the following operations, carried out sequentially:

In operation 1100: depositing molten metal in multiple working areas at the object region of the currently-produced production layer areas according to a building plan setting a deposition path and a deposition velocity.

In operation 1200: by induction heating and while traveling over the deposition path at a predetermined travel velocity, heating the single or multiple working areas, one working area after another. The heating is performed at a working distance which is greater than the mold region height and comprises at least one additional operation from among the following operations:
(1) operation 1300: heating a desired zone in the working areas to a pre-deposition target temperature before depositing metal on the working areas to thereby affect bonding of the molten metal with the working areas, and
(2) operation 1400: heating a desired zone in the working areas to a post-deposition target temperature after depositing metal on the working areas to thereby affect a thermal cooling profile of the working areas.

In some embodiments, a lapse time between the end of pre-heating a specific working area and metal deposition on the specific working area is in a range between 0.05 seconds to 5 seconds.

In some embodiments, the pre-deposition target temperature is substantially identical to a temperature of the molten metal.

In some embodiments, the pre-deposition target temperature is below metal melting temperature and depends on a temperature of the molten metal, which is above metal melting temperature.

In some embodiments, the molten metal is deposited in a specific working area as one or more molten metal drops or as a molten metal stream at a predetermined deposition rate, deposition temperature, and deposition diameter.

In some embodiments, the mold region height is in a range between 2 mm to 12 mm.

In some embodiments, the travel velocity is in a range between 1 mm/sec to 100 mm/sec.

The desired heating zone may have a desired geometry characterized by at least one parameter of a group consisting of: a width in a range of 3 mm to 50 mm; a width equal to or larger than a diameter of the molten metal deposited by the metal deposition unit; and a depth in a range between 1 millimeter to 20 mm.

The invention was described with reference to the use of induction heating for metal deposition in an additive casting process and the integration of the heating system with a deposition system of an additive casting system. The metal deposition system was described with reference to embodiments of the invention where the metal deposition system is integrated by the additive casting system (for example, elements 10, 100 are shown in FIG. 1). For example, the power supply, controller, and sensors (elements 152, 153, 154 shown in FIG. 1) are provided by the additive casting system. The invention is not limited to this example, and other arrangements are feasible within the scope of the invention.

In the additive casting and metal deposition embodiments, the use of mold regions of a certain height prevents the ability to operate the induction heating as close to the workpiece as possible. Working distance constraints may apply to other situations. For example, in a case where sensing the temperature of the working areas before, during, and after heating, a gap between the heating unit and the workpiece may be needed to enable the sensor's line of sight.

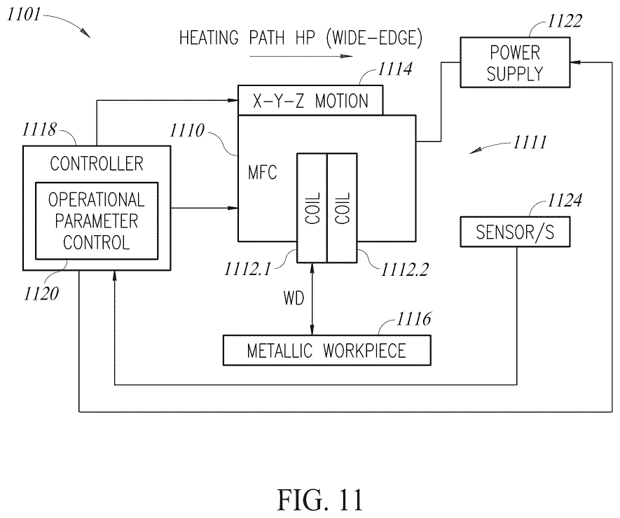

Thus, as illustrated in FIG. 11, in accordance with aspects of the invention, there is provided a heating system 1101 for sequentially heating a metallic workpiece 1116.

In some embodiments, the heating system 1101 is configured for heating multiple working areas of the metallic workpiece 1116, one working area after another according to a heating plan, at a working distance WD which is greater than a predetermined height.

System 1101 may comprise one or more induction units 1111 (one induction unit is shown in FIG. 11). The one or more induction units 1111 may comprise one or more hairpin coils 1112 at a vertical position with respect to the working areas; and a magnetic flux concentrator (MFC) 1110 surrounding hairpin coils 1112.1 and 1112.2. MFC 1110 may increase the range of a magnetic field to include the working areas of workpiece 1116. The one or more induction units 1111 may be construed in accordance with the embodiments described with reference to FIGS. 1-10. As an example, a two-coil configuration (elements 1112.1, 1112.2) with a single MFC 1110 are shown in FIG. 11. As an example only, the geometrical relations between coils 1112.1, 1112.2, and MFC 1110 follow the relations illustrated in FIG. 7D(2).

In some embodiments, the one or more induction units 1111 are movable by an X-Y-Z motion unit 1114 (e.g., a robot, a gantry motion system, and the like). In other embodiments, the motion unit may move the metallic workpiece 1116 (e.g., by a moving stage). The invention is not limited by the motion technique and can be implemented with any motion units that can generate relative motion of one or more induction units over the workpiece at a desired travel velocity.

Heating system 1101 further comprises an induction heating power supply unit 1122 coupled to the at least one induction unit for providing current at a desired magnitude and frequency.

Heating system 1101 comprises controller 1118 for controlling the at least one induction heating unit 1112, the at least one travel unit 1114, and the induction heating power supply unit 1122. A progression along a heating path HP (wide-edge progression) is illustrated in FIG. 11.

In some embodiments, controller 1118 comprises an operational parameter control module 1120.

In some embodiments, operational parameter control module 1120 of controller 1118 is configured to provide the working areas with a target total energy by controlling at least one parameter of a group consisting of: the travel velocity, a provision of electric power to the at least one induction heating unit, a heating dwell time at selected locations of the heating path, and a magnitude of the current.

In some embodiments, operational parameter control module 1120 of controller 1118 is further configured to provide the working areas with a target current density by controlling at least one parameter of a group consisting of: current magnitude provided to each of the at least one induction heating unit, a working distance of the each of the at least one induction heating unit and the work areas.

In some embodiments, heating system 1101 further comprises one or more sensors 1124. For example, sensors 1124 may comprise a temperature sensor for sensing a temperature of the working areas before and after heating. Sensors 1124 may comprise a height sensor for sensing the height of the one or more induction units 1110 above the workpiece 1116. Controller 1118 may be responsive to sensor 1124 readings. For example, controller 1118 may adjust operational parameters of the heating system 1101 in response to sensor 1124 readings.

The heating system 1101 is configured for providing the working areas of the metallic workpiece with a target total energy and a target current density based on properties of the metallic workpiece 1120 by predetermining at least one parameter of a group consisting of: a target temperature of the working areas; a number of hairpin coils; a length of an active heating bottom part of the at least one induction unit; a shape of a cross-section of the at least one hairpin coil; a shape of the at least one hairpin coil; a shape of the one or more magnetic flux concentrator (MFC); a geometrical relationship between the at least one hairpin coil and the one or more magnetic flux concentrator (MFC); an extension of the at least one hairpin coil from the one or more magnetic flux concentrator (MFC) toward the working areas; and an extension of the one or more magnetic flux concentrator (MFC) from the at least one hairpin coil from toward the working areas.

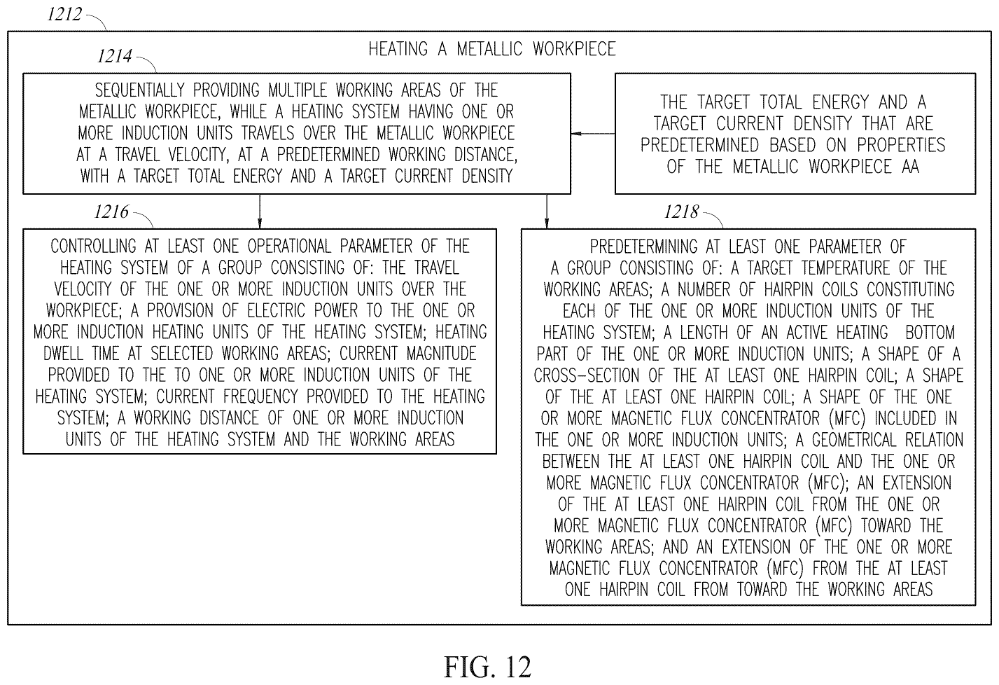

FIG. 12 is a flow chart of a heating method 1212 according to embodiments of the invention. Method 1212 may be carried out by the heating system 1101, illustrated in FIG. 11.

Heating method 1212 may comprise sequentially providing multiple working areas of the metallic workpiece while a heating system having one or more induction units travels over the metallic workpiece at a travel velocity, at a predetermined working distance, with a target total energy and a target current density (operation 1214).

The target total energy and the target current density may be calculated previously, based on the material properties of the metallic workpiece, on considerations as discussed with reference to FIG. 4, and according to known techniques.

In some embodiments, heating system 1101 may be configured for optimizing the total energy and current density. For example, heating system 1101 may be configured for maximizing the energy density and for reaching a target total energy. In some embodiments, optimization of the total energy and current density may be achieved by applying (1) a design operation at which specific design parameters are predetermined and (2) controlling operational parameters of the heating system during its operation (‘on the fly’ control).

Operation 1214 may comprise controlling, on the fly, at least one operational parameter of the heating system of a group consisting of: the travel velocity of the one or more induction units over the workpiece; a provision of electric power to the one or more induction heating units of the heating system; heating dwell time at selected working areas; current magnitude provided to the to one or more induction units of the heating system; current magnitude frequency provided to the to one or more induction units of the heating system; a working distance of one or more induction units of the heating system and the working areas (operation 1216).

Operation 1214 may comprise a design operation, including predetermining at least one parameter of a group consisting of: a target temperature of the working areas; a number of hairpin coils constituting each of the one or more induction units of the heating system; a length of an active heating bottom part of the one or more induction units; a shape of a cross-section of the at least one hairpin coil; a shape of the at least one hairpin coil; a shape of the one or more magnetic flux concentrator (MFC) included in the one or more induction units; a geometrical relationship between the at least one hairpin coil and the one or more magnetic flux concentrator (MFC); an extension of the at least one hairpin coil from the one or more magnetic flux concentrator (MFC) toward the working areas; and an extension of the one or more magnetic flux concentrator (MFC) from the at least one hairpin coil from toward the working areas (operation 1218).

Embodiments of the invention were described with respect to the additive casting of gray iron. The invention is not limited by the type of cast material. The invention is applicable for the additive casting of other metals, including ductile iron, steel, and other metals, with the appropriate modifications.

Aspects of the invention were described with respect to the melt pool embodiments; the invention is applicable for the overheating embodiments, with the appropriate modifications.

Unless specifically stated otherwise, as apparent from the preceding discussions, it is appreciated that, throughout the specification, discussions utilizing terms such as “processing,” “computing,” “calculating,” “determining,” or the like refer to the action and/or processes of a general-purpose computer of any type, such as a client/server system, mobile computing devices, smart appliances, cloud computing units or similar electronic computing devices that manipulate and/or transform data within the computing system's registers and/or memories into other data within the computing system's memories, registers or other such information storage, transmission or display devices.

Embodiments of the invention may include apparatus for performing the operations herein. This apparatus may be specially constructed for the desired purposes, or it may comprise a computing device or system typically having at least one processor and at least one memory, selectively activated or reconfigured by a computer program stored in the computer. The resultant apparatus, when instructed by software, may turn the general-purpose computer into inventive elements as discussed herein. The instructions may define the inventive device in operation with the computer platform for which it is desired. Such a computer program may be stored in a computer readable storage medium, such as, but not limited to, any type of disk, including optical disks, magnetic-optical disks, read-only memories (ROMs), volatile and non-volatile memories, random access memories (RAMS), electrically programmable read-only memories (EPROMs), electrically erasable and programmable read-only memories (EEPROMs), magnetic or optical cards, Flash memory, disk-on-key or any other type of media suitable for storing electronic instructions and capable of being coupled to a computer system bus. The computer readable storage medium may also be implemented in cloud storage.

Some general-purpose computers may comprise at least one communication element to enable communication with a data network and/or a mobile communications network.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A heating system for heating multiple working areas of a metallic workpiece, one working area after another according to a heating plan, the heating system comprising:
at least one induction heating unit for heating the working areas from a working distance which is greater than a predetermined height;
at least one travel unit to provide relative motion according to the heating plan between the at least one induction heating unit and the workpiece at a travel velocity;
an induction heating power supply unit coupled to the at least one induction unit for providing current at a desired magnitude and frequency, said induction heating unit to generate from said current a magnetic field which extends to said working area; and
a controller for controlling the at least one induction heating unit, the at least one travel unit and the induction heating power supply unit,
wherein the at least one induction heating unit comprises:
at least one hairpin coil at a vertical position with respect to the working areas; and
a magnetic flux concentrator (MFC) surrounding said hairpin coil, said MFC to increase the range of a magnetic field to include said working areas.

2. The heating system of claim 1 wherein the MFC is coupled to a heatsink with a cooling fluid flowing therethrough to cool the MFC.

3. The heating system of claim 1 wherein at least one induction heating unit comprises two or more hairpin coils at a vertical position with respect to the working areas, surrounded by one or more magnetic flux concentrator (MFC) arranged to flow current in the two or more hairpin coils in a common direction.

4. The heating system of claim 3 wherein the one or more MFCs are coupled to one or more heatsinks with a cooling fluid flowing therethrough to cool the MFC.

5. The heating system of claim 1 wherein the predetermined height is in a range between 2 to 12 mm.

6. The heating system of claim 1 wherein the travel velocity is in a range between 1 mm/sec to 100 mm/sec.

7. The heating system of claim 1 the controller to provide the working areas with a target total energy by controlling at least one parameter of a group consisting of: the travel velocity, a provision of electric power to the at least one induction heating unit, heating dwell time at selected locations of the heating path, current magnitude.

8. The heating system of claim 1 the controller to provide the working areas with a target current density by controlling at least one parameter of a group consisting of: current magnitude provided to each of the at least one induction heating unit, a working distance of the each of the at least one induction heating unit and the work areas.

9. The heating system of claim 1 and also comprising sensors, wherein the controller is responsive to readings of said sensors indicative of at least one parameter from a group consisting of: a temperature of the working areas before heating, a temperature of the working areas after heating, a height of the at least one heating unit above the working areas.

10. The heating system of claim 1 configured for providing the working areas of the metallic workpiece with a target total energy and a target current density based on properties of the metallic workpiece by predetermining at least one parameter of a group consisting of:
a target temperature of the working areas;
a number of hairpin coils;
a length of an active heating bottom part of the at least one induction unit;
a shape of a cross-section of the at least one hairpin coil;
a shape of the at least one hairpin coil;
a shape of the one or more magnetic flux concentrator (MFC);
a geometrical relation between the at least one hairpin coil and the one or more magnetic flux concentrator (MFC);
an extension of the at least one hairpin coil from the one or more magnetic flux concentrator (MFC) toward the working areas; and
an extension of the one or more magnetic flux concentrator (MFC) from the at least one hairpin coil from toward the working areas.

11. A heating method for sequentially providing multiple working areas of a metallic workpiece, the method comprising:
moving a heating system having one or more induction units over the workpiece at a travel velocity, from a predetermined working distance;
determining properties of the metallic workpiece; and
controlling at least one operational parameters of the heating system to provide a target total energy and a target current density from said properties, said parameters chosen from a group consisting of:
the travel velocity of the one or more induction units over the workpiece;
a provision of electric power to the one or more induction heating units of the heating system;
a heating dwell time at selected working areas;
a magnitude of current provided to the to one or more induction units of the heating system;
a current frequency provided to the to one or more induction units of the heating system; and
a working distance of one or more induction units of the heating system and the working areas.

12. The heating method of claim 11 further comprising, based on properties of the metallic workpiece, predetermining at least one parameter of a group consisting of:
a target temperature of the working areas;
a number of hairpin coils constituting each of the one or more induction units of the heating system;
a length of an active heating bottom part of the one or more induction units;
a shape of a cross-section of the at least one hairpin coil;
a shape of the at least one hairpin coil;
a shape of the one or more magnetic flux concentrator (MFC) included in the one or more induction units;
a geometrical relation between the at least one hairpin coil and the one or more magnetic flux concentrator (MFC);
an extension of the at least one hairpin coil from the one or more magnetic flux concentrator (MFC) toward the working areas; and
an extension of the one or more magnetic flux concentrator (MFC) from the at least one hairpin coil from toward the working areas.

13. The heating method of claim 11 wherein the predetermined working distance is in a range between 2 to 12 mm.

14. The heating system of claim 11 wherein the travel velocity is in a range between 1 mm/sec to 100 mm/sec.

15. The heating method of claim 11 further comprising adjusting at least one operational parameter of the heating system in response to one or more sensor readings of a group consisting of:
sensor readings indicative of a temperature of the working areas before heating;
sensor readings indicative of a temperature of the working areas after heating; and
sensor readings indicative of a height of the one or more induction units above the working areas.
